(19) United States
(12) Patent Application Publication
(10) Pub. No.: US 2022/0178697 A1
(43) Pub. Date: Jun. 9, 2022

(54) METHOD AND APPARATUS FOR CORRECTING YAW ANGLE OF AIRCRAFT, AND AIRCRAFT

(71) Applicant: AUTEL ROBOTICS CO., LTD., Shenzhen (CN)

(72) Inventor: Tianbao ZHANG, Shenzhen (CN)

(21) Appl. No.: 17/652,007

(22) Filed: Feb. 22, 2022

Related U.S. Application Data
(63) Continuation of application No. PCT/CN2020/111310, filed on Aug. 26, 2020.

(30) Foreign Application Priority Data
Aug. 30, 2019 (CN) 201910814909.3

(51) Int. Cl. G01C 21/16; G05D 1/10; B64C 39/02; G01C 25/00

(52) U.S. Cl. CPC G01C 21/16; G05D 1/101; B64C 2201/14; G01C 25/005; B64C 2201/027; B64C 39/024

(57) ABSTRACT

Embodiments of the present application discloses a method and apparatus for correcting a yaw angle of an aircraft and an aircraft. The method includes: acquiring inertial measurement unit (IMU) data and magnetometer data, where the IMU data includes IMU acceleration information and IMU angular velocity information; determining a magnetometer yaw angle according to the magnetometer data; determining an initial value of a yaw angle according to the magnetometer yaw angle; determining an angular velocity compensation quantity of the yaw angle according to the magnetometer data; determining a corrected angular velocity according to the IMU angular velocity information and the angular velocity compensation quantity of the yaw angle; determining a relative value of the yaw angle according to the corrected angular velocity; and generating a fused yaw angle according to the initial value of the yaw angle and the relative value of the yaw angle.

### CROSS-REFERENCE TO RELATED APPLICATIONS

The present application is a continuation of International Application No. PCT/CN2020/111310, filed on Aug. 26, 2020, which claims priority to Chinese Patent Application No. 201910814909.3, filed on Aug. 30, 2019, which is incorporated herein by reference in its entirety.

### TECHNICAL FIELD

The present application relates to the technical field of aircrafts, and in particular, to a method and apparatus for correcting a yaw angle of an aircraft and an aircraft.

### BACKGROUND

Aircrafts, such as an unmanned aerial vehicle (UAV), also known as a drone, are increasingly widely used by virtue of a small size, a light weight, flexibility, a fast response speed, unmanned driving, and low operation requirements. Various actions (or attitudes) of the UAV are usually realized by controlling different rotational speeds of a plurality of driving motors in a power system of the UAV. A yaw angle is a vital parameter for control of the flight attitude of the UAV, that is, fusion of the yaw angle of the UAV is particularly important for the control of the attitude of the UAV. If the fusion of the yaw angle of the UAV has a large error or a low precision, the UAV fails to fly according to a preset direction or trajectory, or severely the UAV may generate an orbiting phenomenon, or even become unstable and explode.

In an indoor environment, magnetic interference to the aircraft is severe, and global position system (GPS) information is weak. Therefore, there is no GPS information correction, a magnetometer is severely interfered, and there is no available information for yaw angle correction. In addition, a gyrointegrator has drift characteristics. Therefore, the aircraft is prone to yaw angle drift when flying or hovering indoors.

Currently, yaw angle correction of the indoor flight of the aircraft mainly relies on visual information correction or magnetometer correction. However, the visual information correction is not feasible for visionless aircrafts. In addition, since a visual computation amount is large, calculation of other visual information by an aircraft having an undesirable visual unit computing capability is affected. In order to avoid the impact, a more desirable visual module is required, increasing the costs. When the magnetometer correction is adopted, a yaw angle of the aircraft is prone to severe deviation or drift under interference. Therefore, how to correct the yaw angle of the aircraft indoors is a problem to be resolved by the disclosure.

### SUMMARY

Embodiments of the disclosure provide a method and apparatus for correcting a yaw angle of an aircraft and an aircraft. In this way, the problem that an indoor aircraft relies on visual information for yaw angle correction and indoor magnetic interference affects the yaw angle correction can be resolved. Therefore, the stability of the aircraft flying or hovering indoors is enhanced.

To resolve the above technical problem, the embodiments of the disclosure provide the following technical solutions.

According to a first aspect, an embodiment of the disclosure provides a method for correcting a yaw angle of an aircraft. The method is applicable to an aircraft. The method includes:

acquiring inertial measurement unit (IMU) data and magnetometer data, where the IMU data includes IMU acceleration information and IMU angular velocity information;

determining a magnetometer yaw angle according to the magnetometer data;

determining an initial value of a yaw angle according to the magnetometer yaw angle;

determining an angular velocity compensation quantity of the yaw angle according to the magnetometer data;

determining a corrected angular velocity according to the IMU angular velocity information and the angular velocity compensation quantity of the yaw angle;

determining a relative value of the yaw angle according to the corrected angular velocity; and

generating a fused yaw angle according to the initial value of the yaw angle and the relative value of the yaw angle.

In some embodiments, the determining a magnetometer yaw angle according to the magnetometer data includes:

calibrating the magnetometer data, to generate calibrated magnetometer data;

acquiring an attitude angle of the aircraft, and generating a rotation transformation matrix according to the attitude angle of the aircraft;

performing coordinate transformation on the calibrated magnetometer data by using the rotation transformation matrix, to generate the magnetometer data in a ground coordinate system; and

comparing magnetometer data of the aircraft in a standard magnetic field at a current position with the magnetometer data in the ground coordinate system, and calculating the magnetometer yaw angle.

In some embodiments, the determining an initial value of a yaw angle according to the magnetometer yaw angle includes:

determining whether the aircraft changes from a stationary state to a moving state at a current moment; and

if so, using the magnetometer yaw angle as the initial value of the yaw angle.

In some embodiments, the determining an angular velocity compensation quantity of the yaw angle according to the magnetometer data includes:

determining a deviation angle of the yaw angle according to the magnetometer yaw angle;

determining a relative deviation angle of the yaw angle according to the deviation angle of the yaw angle; and

determining the angular velocity compensation quantity of the yaw angle according to the relative deviation angle of the yaw angle.

In some embodiments, the determining a deviation angle of the yaw angle according to the magnetometer yaw angle includes:

determining the deviation angle of the yaw angle according to the magnetometer yaw angle and a fused yaw angle at a previous moment.

In some embodiments, the determining a relative deviation angle of the yaw angle according to the deviation angle of the yaw angle includes:

acquiring an above ground altitude of the aircraft and a flight altitude of the aircraft; and

determining the relative deviation angle of the yaw angle according to the deviation angle of the yaw angle, the above ground altitude of the aircraft and the flight altitude of the aircraft.

In some embodiments, the determining the relative deviation angle of the yaw angle according to the deviation angle of the yaw angle, the above ground altitude of the aircraft and the flight altitude of the aircraft includes:

determining, according to the above ground altitude of the aircraft and the flight altitude of the aircraft, a relative offset by which the yaw angle deviates; and

determining the relative deviation angle of the yaw angle according to the deviation angle of the yaw angle and the relative offset by which the yaw angle deviates.

In some embodiments, the determining, according to the above ground altitude of the aircraft and the flight altitude of the aircraft, a relative offset by which the yaw angle deviates includes:

determining the deviation angle of the yaw angle as the relative offset by which the yaw angle deviates when any of the following conditions is satisfied:

the above ground altitude of the aircraft satisfies a first preset condition;

the flight altitude of the aircraft satisfies a second preset condition; or

a differential of the deviation angle of the yaw angle satisfies a third preset condition.

In some embodiments, the first preset condition includes the following:

the above ground altitude of the aircraft is greater than 0.4 m for a duration not less than 0.5s.

In some embodiments, the second preset condition includes the following:

the flight altitude of the aircraft is greater than 0.4 m for a duration not less than 0.5s.

In some embodiments, the third preset condition includes the following:

an absolute value of the differential of the deviation angle of the yaw angle is less than 0.1 for a duration not less than 0.5s.

In some embodiments, the determining the relative deviation angle of the yaw angle according to the deviation angle of the yaw angle and the relative offset by which the yaw angle deviates includes:

determining a relative error compensation value of the yaw angle as the relative deviation angle of the yaw angle when the following conditions are satisfied:

the above ground altitude of the aircraft satisfies the first preset condition or the flight altitude of the aircraft satisfies the second preset condition;

the differential of the deviation angle of the yaw angle satisfies the third preset condition; and

the relative error compensation value of the yaw angle satisfies a fourth preset condition, where the relative error compensation value of the yaw angle is a difference between the deviation angle of the yaw angle and the relative offset by which the yaw angle deviates.

In some embodiments, the fourth preset condition includes the following:

an absolute value of the relative error compensation value of the yaw angle is less than 0.1 for a duration not less than 0.5s.

In some embodiments, the determining the angular velocity compensation quantity of the yaw angle according to the relative deviation angle of the yaw angle includes:

calculating the relative deviation angle of the yaw angle by using a feedback control algorithm, to determine the angular velocity compensation quantity of the yaw angle.

According to a second aspect, an embodiment of the disclosure provides an apparatus for correcting a yaw angle of an aircraft. The apparatus is applicable to an aircraft. the apparatus includes:

an acquisition module, configured to acquire IMU data and magnetometer data, where the IMU data includes IMU acceleration information and IMU angular velocity information;

a determination module, configured to:

determine a magnetometer yaw angle according to the magnetometer data;

determine an initial value of a yaw angle according to the magnetometer yaw angle;

determine an angular velocity compensation quantity of the yaw angle according to the magnetometer data;

determine a corrected angular velocity according to the IMU angular velocity information and the angular velocity compensation quantity of the yaw angle; and

determine a relative value of the yaw angle according to the corrected angular velocity; and

a fused yaw angle generation module, configured to generate a fused yaw angle according to the initial value of the yaw angle and the relative value of the yaw angle.

In some embodiments, the determination module includes a calibration and coordinate system transformation module. The calibration and coordinate system transformation module is configured to:

calibrate the magnetometer data, to generate calibrated magnetometer data;

acquire an attitude angle of the aircraft, and generate a rotation transformation matrix according to the attitude angle of the aircraft;

perform coordinate transformation on the calibrated magnetometer data by using the rotation transformation matrix, to generate the magnetometer data in a ground coordinate system; and

compare magnetometer data of the aircraft in a standard magnetic field at a current position with the magnetometer data in the ground coordinate system, and calculate the magnetometer yaw angle.

In some embodiments, the determination module further includes a stationary state detection module. The stationary state detection module is configured to:

determine whether the aircraft changes from a stationary state to a moving state at a current moment; and

if so, use the magnetometer yaw angle as the initial value of the yaw angle.

In some embodiments, the determination module further includes a yaw angle deviation determination and processing module. The yaw angle deviation determination and processing module is configured to:

determine a deviation angle of the yaw angle according to the magnetometer yaw angle;

determine a relative deviation angle of the yaw angle according to the deviation angle of the yaw angle; and

determine the angular velocity compensation quantity of the yaw angle according to the relative deviation angle of the yaw angle.

In some embodiments, the yaw angle deviation determination and processing module is configured to:

determine the deviation angle of the yaw angle according to the magnetometer yaw angle and a fused yaw angle at a previous moment.

In some embodiments, the yaw angle deviation determination and processing module is configured to:

acquire an above ground altitude of the aircraft and a flight altitude of the aircraft; and

determine the relative deviation angle of the yaw angle according to the deviation angle of the yaw angle, the above ground altitude of the aircraft and the flight altitude of the aircraft.

In some embodiments, the yaw angle deviation determination and processing module includes a logical OR operation module. The logical OR operation module is configured to:

determine the deviation angle of the yaw angle as the relative offset by which the yaw angle deviates when any of the following conditions is satisfied:

the above ground altitude of the aircraft satisfies a first preset condition;

the flight altitude of the aircraft satisfies a second preset condition; or

a differential of the deviation angle of the yaw angle satisfies a third preset condition.

In some embodiments, the first preset condition includes the following:

the above ground altitude of the aircraft is greater than 0.4 m for a duration not less than 0.5s.

In some embodiments, the second preset condition includes the following:

the flight altitude of the aircraft is greater than 0.4 m for a duration not less than 0.5s.

In some embodiments, the third preset condition includes the following:

an absolute value of the differential of the deviation angle of the yaw angle is less than 0.1 for a duration not less than 0.5s.

In some embodiments, the yaw angle deviation determination and processing module includes a logical AND operation module. The logical AND operation module is configured to:

determine a relative error compensation value of the yaw angle as the relative deviation angle of the yaw angle when the following conditions are satisfied:

the above ground altitude of the aircraft satisfies the first preset condition or the flight altitude of the aircraft satisfies the second preset condition;

the differential of the deviation angle of the yaw angle satisfies the third preset condition; and

the relative error compensation value of the yaw angle satisfies a fourth preset condition, where the relative error compensation value of the yaw angle is a difference between the deviation angle of the yaw angle and the relative offset by which the yaw angle deviates.

In some embodiments, the fourth preset condition includes the following:

an absolute value of the relative error compensation value of the yaw angle is less than 0.1 for a duration not less than 0.5s.

In some embodiments, the determination module includes a feedback control module. The feedback control module is configured to:

calculate the relative deviation angle of the yaw angle by using a feedback control algorithm, to determine the angular velocity compensation quantity of the yaw angle.

According to a third aspect, an embodiment of the disclosure provides an aircraft. The aircraft includes:

a fuselage;

an arm, connected to the fuselage;

a power apparatus, disposed on the fuselage and/or the arm and configured to provide flight power for the aircraft; and

a flight controller, disposed on the fuselage and

including:

at least one processor, and

a memory, communicatively connected to the at least one processor.

The memory stores instructions executable by the at least one processor. The instructions, when executed by the at least one processor, cause the at least one processor to perform the foregoing method for correcting a yaw angle of an aircraft.

According to a fourth aspect, an embodiment of the disclosure provides a non-volatile computer readable storage medium. The computer readable storage medium stores computer-executable instructions. The computer-executable instructions cause an aircraft to perform the foregoing method for correcting a yaw angle of an aircraft.

By means of the disclosure, the problem that an indoor aircraft relies on visual information for yaw angle correction and indoor magnetic interference affects the yaw angle correction can be resolved. Therefore, the stability of the aircraft flying or hovering indoors is enhanced.

### BRIEF DESCRIPTION OF THE DRAWINGS

One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1 is a specific structural diagram of an aircraft according to an embodiment of the disclosure.

FIG. 2 is a principle block diagram of a method for correcting a yaw angle of an aircraft according to an embodiment of the disclosure.

FIG. 3 is a schematic diagram of a yaw angle deviation determination and processing algorithm according to an embodiment of the disclosure.

FIG. 4 is a schematic flowchart of a method for correcting a yaw angle of an aircraft according to an embodiment of the disclosure.

FIG. 5 is a detailed flowchart of step S20 in FIG. 4.

FIG. 6 is a detailed flowchart of step S30 in FIG. 4.

FIG. 7 is a detailed flowchart of step S40 in FIG. 4.

FIG. 8 is a detailed flowchart of step S42 in FIG. 7.

FIG. 9 is a detailed flowchart of step S421 in FIG. 8.

FIG. 10 is a detailed flowchart of step S423 in FIG. 8.

FIG. 11 is a schematic structural diagram of an apparatus for correcting a yaw angle of an aircraft according to an embodiment of the disclosure.

FIG. 12 is a schematic structural diagram of a determination module in FIG. 11.

FIG. 13 is a schematic structural diagram of a yaw angle deviation determination and processing module in FIG. 12.

FIG. 14 is a schematic diagram of a hardware structure of an aircraft according to an embodiment of the disclosure.

FIG. 15 is a connection block diagram of an aircraft according to an embodiment of the disclosure.

FIG. 16 is a schematic diagram of a power system in FIG. 15.

### DETAILED DESCRIPTION

To make the objectives, technical solutions, and advantages of the embodiments of the present application clearer, the following clearly and completely describes the technical solutions in the embodiments of the present application with reference to the accompanying drawings in the embodiments of the present application. Apparently, the described embodiments are merely some embodiments of the present application rather than all of the embodiments. All other embodiments obtained by a person of ordinary skill in the art based on the embodiments of the disclosure without creative efforts shall fall within the protection scope of the disclosure.

In addition, technical features involved in implementations of the disclosure that are described below may be combined with each other provided that no conflict occurs.

A method for correcting a yaw angle of an aircraft provided by an embodiment of the disclosure is applicable to various movable objects driven by an electric machine or a motor, including but not limited to an aircraft and a robot. The aircraft may include an unmanned aerial vehicle (UAV), an unmanned spacecraft, and the like.

The method for correcting a yaw angle of an aircraft in this embodiment of the disclosure is applicable to a flight controller of the aircraft.

Referring to FIG. 1, FIG. 1 is a specific schematic structural diagram of an aircraft according to an embodiment of the disclosure.

As shown in FIG. 1, the aircraft 10 includes a fuselage 11, an arm 12 connected to the fuselage 11, a power apparatus 13 disposed on the arm 12, a gimbal 14 connected to a bottom of the fuselage 11, a camera 15 mounted to the gimbal 14, and a flight controller (not shown in the figure) disposed in the fuselage 11.

The flight controller is connected to the power apparatus 13. The power apparatus 13 is mounted to the fuselage 11 to provide flight power for the aircraft 10. Specifically, the flight controller is configured to: perform the above method for correcting a yaw angle of an aircraft to correct a yaw angle of the aircraft, generate a control instruction according to a fused yaw angle of the aircraft, and transmit the control instruction to an electronic speed controller (ESC) of the power apparatus 13. The ESC controls a driving motor of the power apparatus 13 by using the control instruction. Alternatively, the flight controller is configured to: perform the method for correcting a yaw angle of an aircraft to correct the yaw angle of the aircraft, and transmit the corrected yaw angle of the aircraft to the ESC. The ESC generates the control instruction according to the corrected yaw angle of the aircraft, and controls the driving motor of the power apparatus 13 by using the control instruction.

The fuselage 11 includes a center housing and one or more arms connected to the center housing. The one or more arms extend radially from the center housing. The arms and the center housing may be integrally connected or fixedly connected. The power apparatus is mounted to the arm.

The flight controller is configured to: perform the above method for correcting a yaw angle of an aircraft to correct the yaw angle of the aircraft, generate the control instruction according to the corrected yaw angle of the aircraft, and transmit the control instruction to the ESC of the power apparatus. Therefore, the ESC controls the driving motor of the power apparatus by using the control instruction. The controller is a device having a certain logical processing capability, such as a control chip, a single-chip microcomputer, or a microcontroller unit (MCU).

The power apparatus 13 includes the ESC, the driving motor and a propeller. The ESC is located in a cavity formed by the arm or the center housing. The ESC is connected to the controller and the driving motor. Specifically, the ESC is electrically connected to the driving motor to control the driving motor. The driving motor is mounted to the arm. A rotary shaft of the driving motor is connected to the propeller. The propeller generates a force causing the aircraft 10 to move under the driving of the driving motor, for example, lift or thrust causing the aircraft 10 to move.

The aircraft 10 completes each specified speed and each specified action (or attitude) by controlling the driving motor by the ESC. A full name of the ESC is electronic speed controller. The ESC adjusts a rotation speed of the driving motor of the aircraft 10 according to a control signal. The controller is an executive body of the above method for correcting a yaw angle of an aircraft. The ESC controls the driving motor based on the control instruction generated according to the fused yaw angle of the aircraft. A principle of controlling the driving motor by the ESC is roughly as follows: The driving motor is an open-loop control element configured to convert an electrical pulse signal into an angular displacement or a linear displacement. In a non-overload case, the rotation speed and a stop position of the driving motor depend on only a frequency and a pulse count of the pulse signal without being affected by load changes. When a driver receives the pulse signal, the driving motor of the power apparatus is driven to rotate by a fixed angle according to a set direction. The rotation is performed at the fixed angle. Therefore, the ESC may control an angular displacement by controlling a pulse quantity, to achieve accurate positioning. In addition, a pulse frequency may be controlled to control the rotation speed and an acceleration of the driving motor, so as to achieve speed adjustment.

Currently, the aircraft 10 has main functions such as aerial photographing, real-time image transmission and high-risk area detection. In order to implement the functions such as aerial photographing, real-time image transmission and high-risk area detection, a camera assembly is connected to the aircraft 10. Specifically, the aircraft 10 is connected to the camera assembly by using a connection structure, such as a damping ball. The camera assembly is configured to acquire a photographing screen during the aerial photographing of the aircraft 10.

Specifically, the camera assembly includes a gimbal and a camera apparatus. The gimbal is connected to the aircraft 10. The camera apparatus is mounted to the gimbal. The camera apparatus may be an image capture apparatus and configured to capture an image. The camera apparatus includes, but is not limited to, a camera, a video camera, a scanner, or a camera phone. The gimbal is configured to carry the camera apparatus, to fix the camera apparatus or randomly adjust an attitude of the camera apparatus (for example, change a height, an inclination angle and/or an orientation of the camera apparatus), and to stably maintain the camera apparatus at a set attitude. For example, during the aerial photographing of the aircraft 10, the gimbal is mainly configured to stably maintain the camera apparatus at the set attitude and prevent the photographing screen of the camera apparatus from shaking. Therefore, the stability of the photographing screen is guaranteed.

The gimbal 14 is connected to the flight controller, to implement data exchange between the gimbal 14 and the flight controller. For example, the flight controller transmits a yaw instruction to the gimbal 14. The gimbal 14 acquires and executes yaw speed and direction instructions, and transmits data information generated after the yaw instruction is executed to the flight controller. Therefore, the flight controller can detect a current yaw status.

The gimbal includes a gimbal motor and a gimbal base. The gimbal motor is mounted to the gimbal base. The flight controller may further control the gimbal motor by using the ESC of the power apparatus 13. Specifically, the flight controller is connected to the ESC, and the ESC is electrically connected to the gimbal motor. The flight controller generates a gimbal motor control instruction. The ESC controls the gimbal motor by using the gimbal motor control instruction.

The gimbal base is connected to the fuselage of the aircraft to fix and mount the camera assembly to the fuselage of the aircraft.

The gimbal motor is connected to the gimbal base and the camera apparatus. The gimbal may be multi-shaft gimbal. Correspondingly, the gimbal motor includes a plurality of gimbal motors. That is to say, each shaft is provided with a gimbal motor. The gimbal motor can drive the camera apparatus to rotate, to realize horizontal rotation and pitch angle adjustment of a rotary photographing shaft. The gimbal motor is manually remotely controlled to rotate or caused to automatically rotate by using a program, to achieve all-round scanning and monitoring. Moreover, during the aerial photographing of the aircraft, disturbance to the camera apparatus is counteracted in real time by means of the rotation of the gimbal motor. In this way, the camera apparatus is prevented from shaking, and the stability of the photographing screen is guaranteed.

The camera apparatus is carried on the gimbal. An inertial measurement unit (IMU) is disposed on the camera apparatus. The IMU is an apparatus configured to measure a three-axis attitude angle (or angular rate) and an acceleration of an object. Generally, a three-axis gyroscope and a three-directional accelerometer are mounted in the IMU to measure the angular velocity and the acceleration of the object in a three-dimensional space and calculate an attitude of the object based on this. In order to enhance the reliability, more sensors may be further disposed for each shaft. Generally, the IMU is mounted to the center of gravity of the aircraft.

A yaw angle of the aircraft is a vital parameter for controlling the attitude of the aircraft. Therefore, the driving motor is required to be controlled based on the yaw angle of the aircraft. The yaw angle of the aircraft is acquired in real time by using the controller of the aircraft, to provide necessary attitude information for the control of the attitude of the aircraft. That is to say, correct estimation of the yaw angle of the aircraft is extremely important for the control of the attitude of the aircraft. If the yaw angle of the aircraft is wrongly estimated, the aircraft fails to fly according to a preset direction or trajectory, or severely the aircraft becomes unstable and explodes.

In an indoor environment, there is no global position system (GPS) information correction, and the magnetometer is severely interfered. Therefore, there is no sufficient available information for the yaw angle correction. In addition, a gyrointegrator has drift characteristics. Therefore, the aircraft is prone to yaw angle offset when flying or hovering indoors.

Currently, yaw angle correction of the indoor flight of the aircraft mainly relies on visual information correction or magnetometer correction. However, the visual information correction is not feasible for visionless aircrafts. In addition, since a visual computation amount is large, calculation of other visual information by an aircraft having an undesirable visual unit computing capability is affected. In order to avoid the impact, a more desirable visual module is required, increasing the costs. When the magnetometer correction is adopted, a yaw angle of the aircraft is prone to severe deviation or drift under interference.

Therefore, based on the above problem, the embodiments of the disclosure are mainly intended to provide a method and apparatus for correcting a yaw angle of an aircraft and an aircraft. The yaw angle of the aircraft may be corrected based on IMU data and magnetometer data. In this way, the problem that an indoor aircraft relies on visual information for yaw angle correction and indoor magnetic interference affects the yaw angle correction can be resolved. Therefore, the stability of the aircraft flying or hovering indoors is enhanced.

In this embodiment of the disclosure, the IMU data and the magnetometer data are acquired, an initial value of the yaw angle and a relative value of the yaw angle are calculated. The initial value of the yaw angle and the relative value of the yaw angle are fused. By means of the fusion, indoor magnetic interference can be avoided. That is to say, even in the environment lacking a GPS signal and having strong magnetic interference, flying or hovering stability of the aircraft can still be guaranteed.

The embodiments of the disclosure are further described below with reference to the accompanying drawings.

### Embodiment I

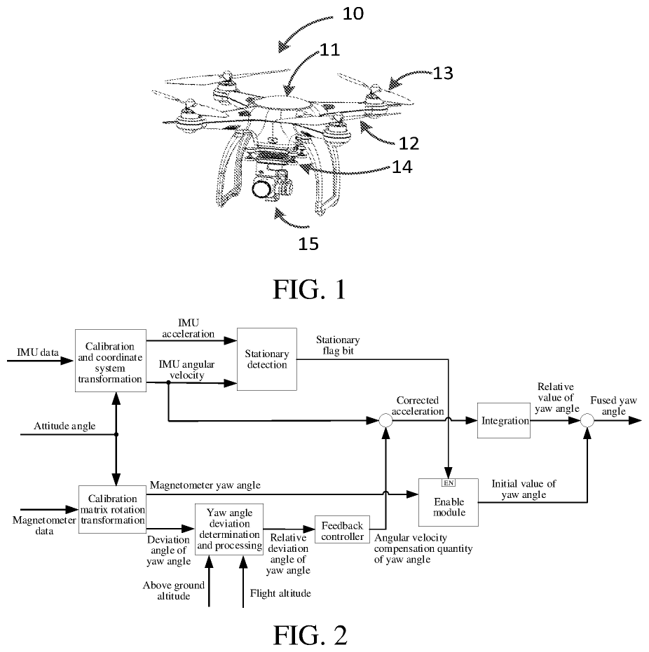

Referring to FIG. 2, FIG. 2 is a principle block diagram of a method for correcting a yaw angle of an aircraft according to an embodiment of the disclosure.

As shown in FIG. 2, IMU data and magnetometer data are acquired, and calibration and coordinate system transformation are performed on the IMU data to acquire an IMU acceleration and an IMU angular velocity. Stationary detection is performed on the aircraft, to generate a stationary flag bit signal. The stationary flag bit signal is inputted to an enable module of the aircraft. A magnetometer yaw angle is outputted as an initial value of the yaw angle according to a rising edge of the stationary flag bit signal. In addition, standard matrix rotation transformation is performed on the magnetometer data to generate the magnetometer yaw angle. A deviation angle of the yaw angle is calculated according to the magnetometer yaw angle and a current fused yaw angle. The deviation angle of the yaw angle is determined and processed to generate a relative deviation angle of the yaw angle. An angular velocity compensation quantity of the yaw angle is generated according to the relative deviation angle of the yaw angle. The IMU angular velocity and the angular velocity compensation quantity of the yaw angle generated according to the magnetometer data are further fused to generate a corrected acceleration. The corrected acceleration is integrated to obtain a relative value of the yaw angle. The initial value of the yaw angle and the relative value of the yaw angle are fused to generate a fused yaw angle.

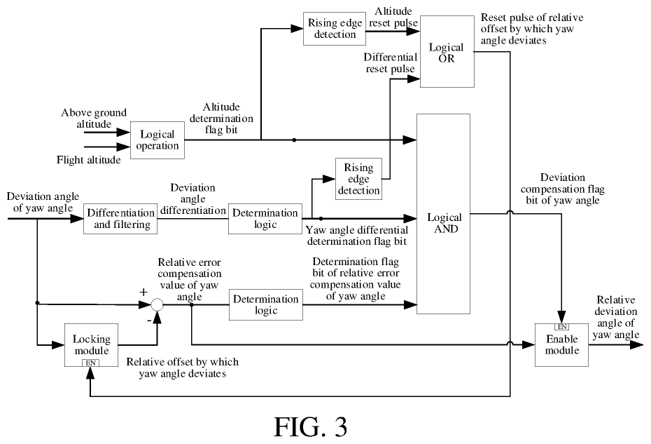

Referring to FIG. 3, FIG. 3 is a schematic diagram of a yaw angle deviation determination and processing algorithm according to an embodiment of the disclosure.

As shown in FIG. 3, data such as an above ground altitude and a flight altitude is acquired and corresponding logical operation or processing is performed on the above data to generate the relative deviation angle of the yaw angle.

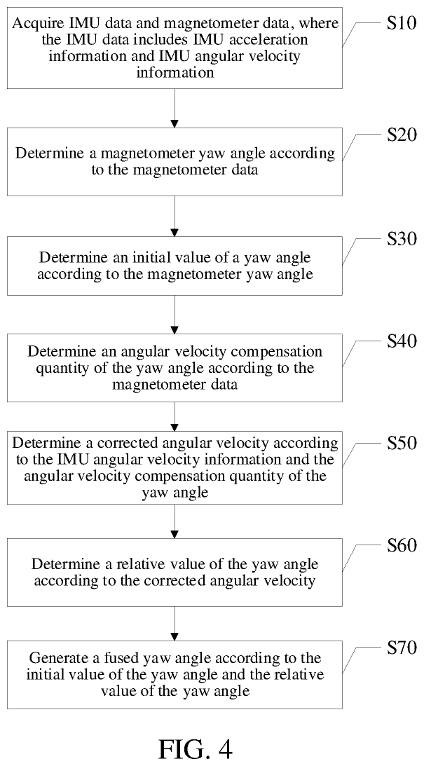

Referring to FIG. 4, FIG. 4 is a schematic flowchart of a method for correcting a yaw angle of an aircraft according to an embodiment of the disclosure.

The method for correcting a yaw angle of an aircraft may be performed by various electronic devices having a certain logical processing capability, such as an aircraft or a control chip. The aircraft may include a UAV, an unmanned ship, or the like. That the electronic device is the aircraft is used as an example for description below. The aircraft is connected to the gimbal. The gimbal includes a gimbal motor and a gimbal base. The gimbal may be a multi-shaft gimbal, such as a two-axis gimbal or a three-axis gimbal. The three-axis gimbal is used as an example for description below. For description of specific structures of the aircraft and the gimbal, refer to the above description. Details are not described herein again.

As shown in FIG. 4, the method is applicable to an aircraft, such as an UAV. The method includes the following steps:

Step S10: Acquiring IMU data and magnetometer data, where the IMU data includes IMU acceleration information and IMU angular velocity information.

Specifically, the aircraft is provided with an attitude sensor assembly. The attitude sensor assembly includes an IMU, a magnetometer, and the like. The IMU is configured to acquire the IMU data. The magnetometer is configured to acquire the magnetometer data. The IMU includes a gyroscope and an accelerometer. The gyroscope is configured to acquire an IMU angular velocity. The magnetometer is configured to acquire the IMU acceleration information. The IMU data includes the IMU acceleration information and the IMU angular velocity information. The magnetometer data includes magnetic field strength information.

Specifically, the IMU data is acquired by using the IMU. Calibration and coordinate system transformation are performed on the IMU data to generate the IMU acceleration information and the IMU angular velocity information. The IMU acceleration information is acceleration information in a ground coordinate system obtained after measurement data of the IMU is calibrated by a calibration matrix and coordinate transformation from a fuselage coordinate system to the ground coordinate system is performed on the measurement data. It may be understood that, the calibration matrix is calibrated by a user at a flight place. The calibration matrix varies on the earth. The aircraft can determine the calibration matrix only after reporting the magnetometer interference and requiring the user to perform calibration.

The transformation from the fuselage coordinate system to the ground coordinate system is completed by a rotation transformation matrix. Specifically, the rotation transformation matrix is generated according to an attitude angle of the aircraft. The IMU data is transformed from the fuselage coordinate system to the ground coordinate system by the rotation transformation matrix, to generate the IMU acceleration information and the IMU angular velocity information. Specifically, the attitude angle of the aircraft includes a yaw angle, a pitch angle, and a roll angle. The yaw angle is the current fused yaw angle. That is to say, a real-time fused yaw angle is used for calculating the rotation transformation matrix for next fusion. In this way, the fused yaw angle is continuously updated. For example, the rotation transformation matrix is a 3*3 matrix. The matrix includes sine-cosine functions of the yaw angle, the pitch angle, and the roll angle. Different functions are selected according to specific conditions. Generally, the yaw angle is first rotated, then the pitch angle is rotated, and finally the roll angle is rotated. For example, the rotation transformation matrix is:

$$D = [ \begin{matrix}cos ψ & - cos ϕsinψ & 0 \\ sin ψ & cos ϕcosψ & 0 \\ 0 & sin ϕ & 1\end{matrix} ]$$

where (ϕ, θ, ψ) is the attitude angle, ϕ is the roll angle in the attitude angle, θ is the pitch angle in the attitude angle, and ψ is the yaw angle in the attitude angle.

Step S20: Determining a magnetometer yaw angle according to the magnetometer data.

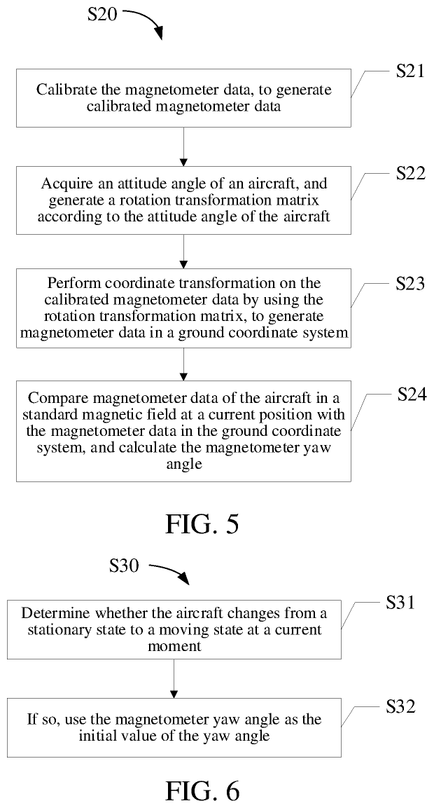

The magnetometer data is acquired by using the magnetometer. The magnetometer data includes magnetic field strength information. The magnetic field strength is a triaxial magnetic field strength. Since the magnetometer data measured by the magnetometer is the triaxial magnetic field strength in the fuselage coordinate system, bias and cross couplings are required to be removed by means of the calibration matrix. In addition, the magnetometer data is transformed into the ground coordinate system by means of a rotation matrix. Specifically, referring to FIG. 5, FIG. 5 is a detailed flowchart of step S20 in FIG. 4.

As shown in FIG. 5, the determining a magnetometer yaw angle according to the magnetometer data includes the following steps:

Step S21: Calibrating the magnetometer data, to generate calibrated magnetometer data.

Calibration is performed on the magnetometer data according to a preset calibration matrix, to generate calibrated magnetometer data. Specifically, the preset calibration matrix is calibrated by a user at a flight place. The calibration matrix varies on the earth. The aircraft can determine the calibration matrix only after reporting the magnetometer interference and requiring the user to perform calibration.

Step S22: Acquiring an attitude angle of the aircraft, and generate a rotation transformation matrix according to the attitude angle of the aircraft.

Specifically, the rotation transformation matrix is used for transforming the fuselage coordinate system into the ground coordinate system. The attitude angle of the aircraft includes the yaw angle, the pitch angle, and the roll angle. The attitude angle of the aircraft is acquired. The yaw angle is the current fused yaw angle. That is to say, a real-time fused yaw angle is used for calculating the rotation transformation matrix for next fusion. In this way, the fused yaw angle is continuously updated. The rotation transformation matrix is a 3*3 matrix. The matrix includes sine-cosine functions of the yaw angle, the pitch angle, and the roll angle. Different functions are selected according to specific conditions. Generally, the yaw angle is first rotated, then the pitch angle is rotated, and finally the roll angle is rotated. For example, the rotation transformation matrix is:

$$D = [ \begin{matrix}cos ψ & - cos ϕsinψ & 0 \\ sin ψ & cos ϕcosψ & 0 \\ 0 & sin ϕ & 1\end{matrix} ]$$

where (ϕ, θ, ψ) is the attitude angle, ϕ is the roll angle in the attitude angle, θ is the pitch angle in the attitude angle, and ψ is the yaw angle in the attitude angle.

Step S23: Performing coordinate transformation on the calibrated magnetometer data by using the rotation transformation matrix, to generate the magnetometer data in a ground coordinate system.

Specifically, the calibrated magnetometer data, that is, the magnetic field strength, is multiplied by the rotation transformation matrix, to generate the magnetic field strength in the ground coordinate system. That is to say, the magnetometer data is transformed between the fuselage coordinate system and the ground coordinate system. After the coordinate transformation, the magnetometer data in the ground coordinate system is generated.

Step S24: Comparing magnetometer data of the aircraft in a standard magnetic field at a current position with the magnetometer data in the ground coordinate system, and calculating the magnetometer yaw angle.

Specifically, the current position of the aircraft corresponds to a standard magnetic field. The triaxial readings of the magnetometer form a vector. The magnetometer data of the standard magnetic field at the current position corresponds to a vector. The magnetometer data in the ground coordinate system is compared with the magnetometer data of the standard magnetic field at the current position of the aircraft, and a vetorial angle between the two is calculated. The vetorial angle is used as the magnetometer yaw angle.

Step S30: Determining an initial value of a yaw angle according to the magnetometer yaw angle

Specifically, an enable module is disposed on the aircraft. The enable module includes an input end and an output end. When the enable module receives a rising edge of a stationary flag bit signal, the enable module outputs the magnetometer yaw angle as the initial value of the yaw angle.

Specifically, referring to FIG. 6, FIG. 6 is a detailed flowchart of step S30 in FIG. 4. As shown in FIG. 6, the determining an initial value of a yaw angle according to the magnetometer yaw angle includes the following steps:

Step S31: Determining whether the aircraft changes from a stationary state to a moving state at a current moment.

Specifically, the stationary flag bit signal of the aircraft is determined according to a stationary state of the aircraft. The stationary flag bit signal of the aircraft is used for representing the stationary state of the aircraft. Determining the stationary flag bit signal of the aircraft according to the stationary state of the aircraft includes: acquiring an IMU acceleration and an IMU angular velocity in the IMU data, and performing stationary detection on the IMU acceleration and the IMU angular velocity to determine the stationary state of the aircraft. If the state of the aircraft is stationary, a value of a stationary state bit is 1. If the state of the aircraft is moving, a value of the stationary state bit is 0. It may be understood that, the IMU acceleration and the IMU angular velocity have very small data fluctuations and are very stable in the stationary state. The IMU acceleration and the IMU angular velocity have large data fluctuations in the moving state. Therefore, the stationary state of the aircraft can be determined according to the principle. The method specifically includes: performing, on the IMU data, transformation from the fuselage coordinate system and the ground coordinate system according to the rotation transformation matrix, to generate the IMU acceleration in the ground coordinate system and the IMU angular velocity in the ground coordinate system; and determining the stationary state of the aircraft according to the IMU acceleration in the ground coordinate system and the IMU angular velocity in the ground coordinate system, to generate the stationary flag bit of the aircraft.

Step S32: If so, using the magnetometer yaw angle as the initial value of the yaw angle.

Specifically, the stationary flag bit signal is inputted to the enable module of the aircraft. When the enable module detects that there is the stationary flag bit signal has a rising edge, the magnetometer yaw angle is outputted as the initial value of the yaw angle. The stationary flag bit signal is 0 when the aircraft is stationary, and is 1 when the aircraft is moving. The stationary flag bit signal is inputted to the enable module of the aircraft. When the enable module detects that the stationary flag bit signal has a rising edge, that is to say, the stationary state bit changes from 0 to 1, the enable module outputs the magnetometer yaw angle as the initial value of the yaw angle.

Step S40: Determining an angular velocity compensation quantity of the yaw angle according to the magnetometer data.

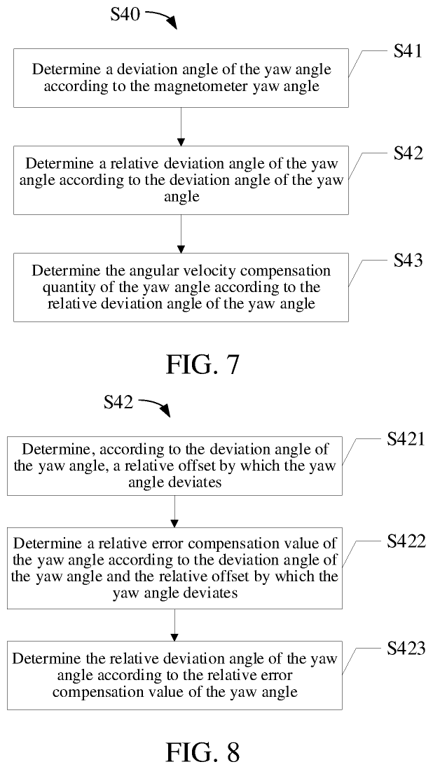

Specifically, due to severe indoor magnetic interference, the IMU data measured by the IMU is required to be corrected. The angular velocity compensation quantity of the yaw angle is used for correcting the IMU angular velocity acquired by the IMU. The angular velocity compensation quantity of the yaw angle is required to be determined by using the magnetometer yaw angle. Specifically, referring to FIG. 7, FIG. 7 is a detailed flowchart of step S40 in FIG. 4.

As shown in FIG. 7, determining the angular velocity compensation quantity of the yaw angle according to the magnetometer yaw angle includes the following steps:

Step S41: Determining a deviation angle of the yaw angle according to the magnetometer yaw angle.

Specifically, the determining a deviation angle of the yaw angle according to the magnetometer yaw angle includes: determining the deviation angle of the yaw angle according to the magnetometer yaw angle and a fused yaw angle at a previous moment. The current fused yaw angle is a real-time fused yaw angle. A difference between the current fused yaw angle and the magnetometer yaw angle is used as the deviation angle of the yaw angle.

Step S42: Determining a relative deviation angle of the yaw angle according to the deviation angle of the yaw angle.

Specifically, the determining a relative deviation angle of the yaw angle according to the deviation angle of the yaw angle includes:

acquiring an above ground altitude of the aircraft and a flight altitude of the aircraft; and

determining the relative deviation angle of the yaw angle according to the deviation angle of the yaw angle, the above ground altitude of the aircraft and the flight altitude of the aircraft.

Specifically, the determining the relative deviation angle of the yaw angle according to the deviation angle of the yaw angle, the above ground altitude of the aircraft and the flight altitude of the aircraft includes:

determining, according to the above ground altitude of the aircraft and the flight altitude of the aircraft, a relative offset by which the yaw angle deviates; and

determining the relative deviation angle of the yaw angle according to the deviation angle of the yaw angle and the relative offset by which the yaw angle deviates.

Specifically, the determining, according to the above ground altitude of the aircraft and the flight altitude of the aircraft, a relative offset by which the yaw angle deviates includes:

determining the deviation angle of the yaw angle as the relative offset by which the yaw angle deviates when any of the following conditions is satisfied:

the above ground altitude of the aircraft satisfies a first preset condition;

the flight altitude of the aircraft satisfies a second preset condition; or

a differential of the deviation angle of the yaw angle satisfies a third preset condition.

The first preset condition includes: the above ground altitude of the aircraft is greater than 0.4 m for a duration not less than 0.5 s. The second preset condition includes: the flight altitude of the aircraft is greater than 0.4 m for a duration not less than 0.5s. The third preset condition includes: an absolute value of the differential of the deviation angle of the yaw angle is less than 0.1 for a duration not less than 0.5s.

The relative deviation angle of the yaw angle is a relative deviation value of the yaw angle obtained by determining and processing the deviation angle of the yaw angle. Specifically, referring to FIG. 8, FIG. 8 is a detailed flowchart of step S42 in FIG. 7.

As shown in FIG. 8, the determining a relative deviation angle of the yaw angle according to the deviation angle of the yaw angle includes the following steps:

Step S421: Determining, according to the deviation angle of the yaw angle, the relative offset by which the yaw angle deviates.

Specifically, the aircraft is provided with a locking module. The locking module is configured to lock the deviation angle of the yaw angle. When receiving a valid signal, the locking module outputs the deviation angle of the yaw angle as the relative offset by which the yaw angle deviates, continuously locks the deviation angle of the yaw angle until a next valid signal arrives, and updates the relative offset by which the yaw angle deviates.

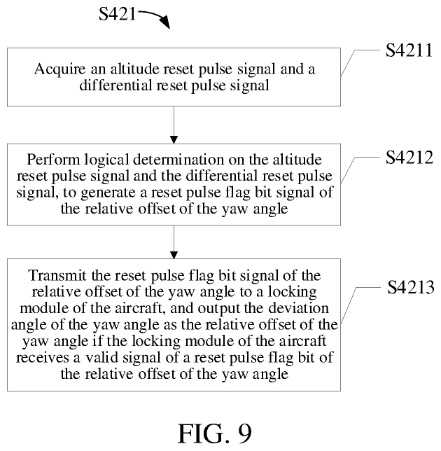

Referring to FIG. 9, FIG. 9 is a detailed flowchart of step S421 in FIG. 8.

As shown in FIG. 9, the determining, according to the deviation angle of the yaw angle, the relative offset by which the yaw angle deviates includes the following steps:

Step S4211: Acquiring an altitude reset pulse signal and a differential reset pulse signal.

Specifically, the acquiring an altitude reset pulse signal includes the following steps:

An above ground altitude and a flight altitude of the aircraft are acquired.

Specifically, the above ground altitude of the aircraft is a distance of a position of the aircraft during flight from the ground directly below the aircraft. The flight altitude of the aircraft is a height difference between the position of the aircraft during the flight and a take-off point. The aircraft is provided with an ultrasonic sensor and/or a time of flight (TOF) sensor. The above ground altitude and the flight altitude of the aircraft are acquired by using the ultrasonic sensor and/or the TOF sensor.

An altitude determination flag bit signal of the aircraft is determined according to the above ground altitude and the flight altitude.

The altitude determination flag bit signal is used for eliminating magnetic interference of reinforced concrete inside the floor. Specifically, an above ground altitude threshold and a duration threshold thereof are preset. If the above ground altitude of the aircraft is greater than the above ground altitude threshold for a duration greater than the duration threshold, the altitude determination flag bit signal is outputted as a high level. Otherwise, the altitude determination flag bit signal is outputted as a low level. Alternatively, a flight altitude threshold and a duration threshold thereof are preset. If the flight altitude of the aircraft is greater than the flight altitude threshold for a duration greater than the duration threshold, the altitude determination flag bit signal is outputted as the high level. Otherwise, the altitude determination flag bit signal is outputted as the low level. For example, the above ground altitude threshold and the duration threshold thereof are respectively preset to 0.4 m and 0.5s, and the flight altitude threshold and the duration threshold thereof are respectively preset to 0.4 m and 0.5s. When the above ground altitude of the aircraft is greater than 0.4 m for a duration greater than 0.5s, the altitude determination flag bit signal is outputted as 1. Alternatively, when the flight altitude of the aircraft is greater than 0.4 m for a duration greater than 0.5s, the altitude determination flag bit signal is outputted 1. Otherwise, the altitude determination flag bit signal is outputted as 0. It may be understood that, in this embodiment of the disclosure, the above ground altitude threshold and the duration threshold thereof as well as the flight altitude threshold and the duration threshold thereof may be specifically set according to specific requirements, which all fall within the protection scope of the disclosure.

If the altitude determination flag bit signal of the aircraft has a rising edge, the altitude reset pulse signal is generated.

Specifically, the controller of the aircraft is provided with a rising edge detection module. The rising edge detection module acquires the altitude determination flag bit signal, determines whether the altitude determination flag bit signal has a rising edge, and if so, generates the altitude reset pulse signal.

Specifically, the acquiring a differential reset pulse signal includes the following steps:

The deviation angle of the yaw angle is differentiated and filtered, to generate a differential value of the yaw angle.

Specifically, the deviation angle of the yaw angle is differentiated and filtered. By differentiating the yaw angle, an initial differential value of the yaw angle is acquired. By filtering the initial differential value of the yaw angle, a final differential value of the yaw angle, that is, the differential value of the yaw angle is generated. The filtering includes lowpass filtering and Kalman filtering, and is completed by using a lowpass filter and a Kalman filter of the aircraft respectively.

Logical determination is performed on the differential value of the yaw angle, to determine a yaw angle differential determination flag bit signal.

Specifically, the controller of the aircraft is provided with a logical determination module. The logical determination module acquires the differential value of the yaw angle, and performs logical determination on the differential value of the yaw angle to generate the yaw angle differential determination flag bit signal. Determination logic of the logical determination module for the differential value of the yaw angle includes presetting an absolute differential value threshold and a duration threshold thereof. If the differential value of the yaw angle is less than the absolute differential value threshold for a duration greater than the duration threshold, the yaw angle differential determination flag bit signal is outputted as the high level. Otherwise, the yaw angle differential determination flag bit signal is outputted as the low level. For example, the absolute differential value threshold is preset to 0.1, and the duration threshold is preset to 0.5s. If an absolute value of the differential value of the yaw angle is less than 0.1 for a duration greater than 0.5s, the yaw angle differential determination flag bit signal is outputted as 1. Otherwise, the yaw angle differential determination flag bit signal is outputted as 0. It may be understood that, the absolute differential value threshold and the duration threshold thereof may be specifically set according to specific requirements, which all fall within the protection scope of the disclosure.

If the yaw angle differential determination flag bit signal has a rising edge, the differential reset pulse signal is generated.

Specifically, the rising edge detection module of the aircraft acquires the yaw angle differential determination flag bit signal, determines whether the yaw angle differential determination flag bit signal has a rising edge, and if so, generates the differential reset pulse signal and outputs the differential reset pulse signal as the high level, or otherwise, outputs the differential reset pulse signal as the low level.

Step S4212: Performing logical determination on the altitude reset pulse signal and the differential reset pulse signal, to generate a reset pulse flag bit signal of the relative offset of the yaw angle.

Specifically, logical OR operation is performed on the altitude reset pulse signal and the differential reset pulse signal. A result after the logical OR operation is used as the reset pulse flag bit signal of the relative offset of the yaw angle. For example, if any of the altitude reset pulse signal or the differential reset pulse signal is the high level, the reset pulse flag bit signal of the relative offset of the yaw angle is the high level. If the altitude reset pulse signal and the differential reset pulse signal are both the low level, the reset pulse flag bit signal of the relative offset of the yaw angle is the low level.

Step S4213: Transmitting the reset pulse flag bit signal of the relative offset of the yaw angle to the locking module of the aircraft, and outputting the deviation angle of the yaw angle as the relative offset of the yaw angle if the locking module of the aircraft receives a valid reset pulse flag bit signal of the relative offset of the yaw angle.

Specifically, the valid signal is a high level signal, that is, 1. If the reset pulse flag bit signal of the relative offset of the yaw angle is the high level, the locking module of the aircraft outputs the deviation angle of the yaw angle as the relative offset of the yaw angle. If the reset pulse flag bit signal of the relative offset of the yaw angle is the low level, the locking module of the aircraft continuously locks the deviation angle of the yaw angle until receiving the valid reset pulse flag bit signal of the relative offset of the yaw angle. That is to say, the reset pulse flag bit signal of the relative offset of the yaw angle is the high level signal.

Step S422: Determining a relative error compensation value of the yaw angle according to the deviation angle of the yaw angle and the relative offset by which the yaw angle deviates.

Specifically, the relative error compensation value of the yaw angle is calculated by using a formula: the relative error compensation value of the yaw angle=the deviation angle of the yaw angle—the relative offset by which the yaw angle deviates.

Step S423: Determining a relative deviation angle of the yaw angle according to the relative error compensation value of the yaw angle.

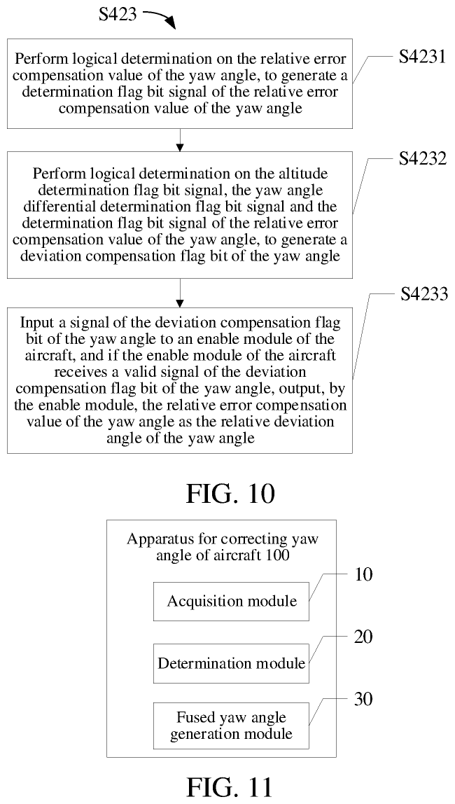

Specifically, referring to FIG. 10, FIG. 10 is a detailed flowchart of step S423 in FIG. 8.

As shown in FIG. 10, the determining a relative deviation angle of the yaw angle according to the relative error compensation value of the yaw angle includes the following steps:

Step S4231: Performing logical determination on the relative error compensation value of the yaw angle, to generate a determination flag bit signal of the relative error compensation value of the yaw angle.

Specifically, the logical determination module of the aircraft acquires the relative error compensation value of the yaw angle, and performs logical determination on the relative error compensation value of the yaw angle. A determination logic of the logical determination module for the relative error compensation value of the yaw angle includes presetting an absolute compensation value threshold and a duration threshold thereof. If the relative error compensation value of the yaw angle is less than the absolute compensation value threshold for a duration greater than the duration threshold, the determination flag bit signal of the relative error compensation value of the yaw angle is outputted as the high level. Otherwise, the determination flag bit signal of the relative error compensation value of the yaw angle is outputted as the low level. For example, the absolute compensation value threshold is preset to 0.1, and the duration threshold is preset to 0.5s. if an absolute value of the relative error compensation value of the yaw angle is less than 0.1 for a duration greater than 0.5s, the determination flag bit signal of the relative error compensation value of the yaw angle is outputted as 1. Otherwise, the determination flag bit signal of the relative error compensation value of the yaw angle is outputted as 0. It may be understood that, the absolute compensation value threshold and the duration threshold thereof may be specifically set according to specific requirements, which all fall within the protection scope of the disclosure.

Step S4232: Performing logical determination on the altitude determination flag bit signal, the yaw angle differential determination flag bit signal, and the determination flag bit signal of the relative error compensation value of the yaw angle, to generate a deviation compensation flag bit of the yaw angle.

Specifically, logical AND operation is performed on the altitude determination flag bit signal, the yaw angle differential determination flag bit signal, and the determination flag bit signal of the relative error compensation value of the yaw angle to determine a value of the deviation compensation flag bit of the yaw angle. The deviation compensation flag bit of the yaw angle is used for determining whether the relative error compensation value of the yaw angle can be used for compensation. If the deviation compensation flag bit of the yaw angle is the high level, it means that the relative error compensation value of the yaw angle can be used for compensation. If the deviation compensation flag bit of the yaw angle is the low level, it means that the relative error compensation value of the yaw angle cannot be used for compensation. For example, if the altitude determination flag bit signal, the yaw angle differential determination flag bit signal, and the determination flag bit signal of the relative error compensation value of the yaw angle are all the high level, a value obtained by the logical determination module of the aircraft after performing the logical AND operation on the altitude determination flag bit signal, the yaw angle differential determination flag bit signal, and the determination flag bit signal of the relative error compensation value of the yaw angle is the high level. In this case, the deviation compensation flag bit of the yaw angle is outputted as the high level. Alternatively, if any of the altitude determination flag bit signal, the yaw angle differential determination flag bit signal, and the determination flag bit signal of the relative error compensation value of the yaw angle is the low level, the value obtained by the logical determination module of the aircraft after performing the logical AND operation on the altitude determination flag bit signal, the yaw angle differential determination flag bit signal, and the determination flag bit signal of the relative error compensation value of the yaw angle is the low level, and the deviation compensation flag bit of the yaw angle is outputted as the low level.

Step S4233: Inputting a signal of the deviation compensation flag bit of the yaw angle to the enable module of the aircraft, and if the enable module of the aircraft receives a valid signal of the deviation compensation flag bit of the yaw angle, outputting, by the enable module, the relative error compensation value of the yaw angle as the yaw angle relative deviation angle.

Specifically, if a result obtained by performing the logical AND operation on the altitude determination flag bit signal, the yaw angle differential determination flag bit signal, and the determination flag bit signal of the relative error compensation value of the yaw angle is the high level, that is, yaw angle the deviation compensation flag bit is outputted as the valid signal, the enable module of the aircraft outputs the relative error compensation value of the yaw angle as the relative deviation angle of the yaw angle.

Step S43: Determining the angular velocity compensation quantity of the yaw angle according to the relative deviation angle of the yaw angle.

Specifically, the aircraft is provided with a feedback controller. The relative deviation angle of the yaw angle is inputted to the feedback controller. The feedback controller calculates the relative deviation angle of the yaw angle by using a feedback control algorithm, to determine the angular velocity compensation quantity of the yaw angle. For example, the angular velocity compensation quantity of the yaw angle is negatively correlated with the relative deviation angle of the yaw angle. For example, the angular velocity compensation quantity of the yaw angle=−K* the relative deviation angle of the yaw angle, where K is an engineer design value.

Step S50: Determining a corrected angular velocity according to the IMU angular velocity information and the angular velocity compensation quantity of the yaw angle.

Specifically, the IMU angular velocity information and the angular velocity compensation quantity of the yaw angle are summed, and an obtained sum is used as a corrected angular velocity. For example, the corrected angular velocity=the IMU angular velocity information+the angular velocity compensation quantity of the yaw angle.

Step S60: Determining a relative value of the yaw angle according to the corrected angular velocity.

Specifically, the corrected angular velocity is integrated. An integral value of the corrected angular velocity is used as the relative value of the yaw angle.

Step S70: Generating a fused yaw angle according to the initial value of the yaw angle and the relative value of the yaw angle.

Specifically, the initial value of the yaw angle and the relative value of the yaw angle are summed, and an obtained sum is used as the fused yaw angle. For example, the fused yaw angle=the initial value of the yaw angle+the relative value of the yaw angle.

Specifically, an error calculation is ceaselessly performed for each sampling step of the aircraft by a feedback loop. The fused yaw angle is compared with the magnetometer yaw angle to generate an error angle of the yaw angle. The operation is performed endlessly until the aircraft is powered off. The fused yaw angle is updated endlessly. Each sampling moment corresponds to a unique fused yaw angle. The error angle of the yaw angle is a difference between the magnetometer yaw angle and the fusion yaw angle.

In this embodiment of the disclosure, the method for correcting a yaw angle of an aircraft and an aircraft is provided. The method includes: acquiring the IMU data and magnetometer data, where the IMU data includes the IMU acceleration information and the IMU angular velocity information; determining the magnetometer yaw angle according to the magnetometer data; determining the initial value of the yaw angle according to the magnetometer yaw angle; determining the angular velocity compensation quantity of the yaw angle according to the magnetometer data; determining the corrected angular velocity according to the IMU angular velocity information and the angular velocity compensation quantity of the yaw angle; determining the relative value of the yaw angle according to the corrected angular velocity; and generating the fused yaw angle according to the initial value of the yaw angle and the relative value of the yaw angle. The IMU data and the magnetometer data are acquired, the initial value of the yaw angle and the relative value of the yaw angle are calculated. Full, proper and skillful yaw angle correction is performed by using the magnetometer information. Rather than relying on visual information, only the disturbed magnetometer is used to stabilize the yaw angle and improve the fusion accuracy. In this way, indoor magnetic interference can be avoided. That is to say, even in an environment lacking a GPS signal and having strong magnetic interference, flying or hovering stability of the aircraft can still be guaranteed.

### Embodiment II

Referring to FIG. 11, FIG. 11 is a schematic diagram of an apparatus for correcting a yaw angle of an aircraft according to an embodiment of the disclosure.

As shown in FIG. 11, the apparatus 100 for correcting a yaw angle of an aircraft is applicable to an aircraft. The apparatus includes:

an acquisition module 10, configured to acquire IMU data and magnetometer data, where the IMU data includes IMU acceleration information and IMU angular velocity information;

a determination module 20, configured to: determine a magnetometer yaw angle according to the magnetometer data;

determine an initial value of a yaw angle according to the magnetometer yaw angle;

determine an angular velocity compensation quantity of the yaw angle according to the magnetometer yaw angle;

determine a corrected angular velocity according to the IMU angular velocity information and the angular velocity compensation quantity of the yaw angle; and

determine a relative value of the yaw angle according to the corrected angular velocity; and

a fused yaw angle generation module 30, configured to generate a fused yaw angle according to the initial value of the yaw angle and the relative value of the yaw angle.

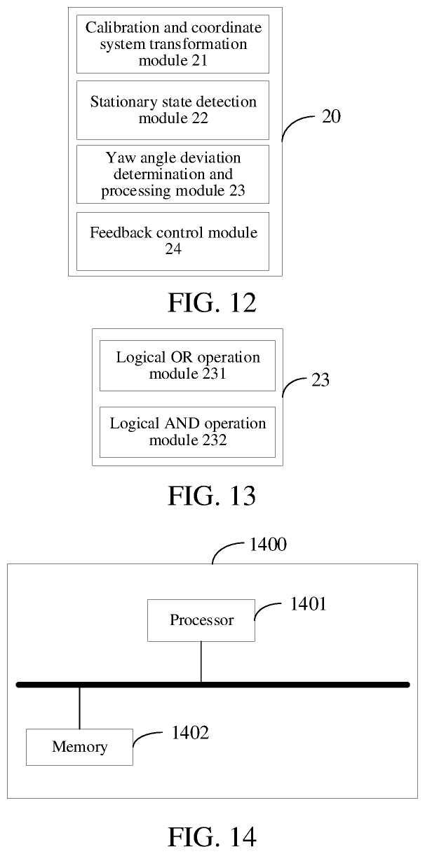

Referring to FIG. 12, FIG. 12 is a schematic structural diagram of the determination module in FIG. 11.

As shown in FIG. 12, the determination module 20 includes a calibration and coordinate system transformation module 21, a stationary state detection module 22, a yaw angle deviation determination and processing module 23, and a feedback control module 24.

Specifically, the calibration and coordinate system transformation module 21 is configured to:

calibrate the magnetometer data, to generate calibrated magnetometer data;

acquire an attitude angle of the aircraft, and generate a rotation transformation matrix according to the attitude angle of the aircraft;

perform coordinate transformation on the calibrated magnetometer data by using the rotation transformation matrix, to generate the magnetometer data in a ground coordinate system; and

compare magnetometer data of the aircraft in a standard magnetic field at a current position with the magnetometer data in the ground coordinate system, and calculate the magnetometer yaw angle.

In this embodiment of the disclosure, the determination module 20 further includes the stationary state detection module 22. The stationary state detection module 22 is configured to:

determine whether the aircraft changes from a stationary state to a moving state at a current moment; and

if so, use the magnetometer yaw angle as the initial value of the yaw angle.

Specifically, the yaw angle deviation determination and processing module 23 is configured to:

determine a deviation angle of the yaw angle according to the magnetometer yaw angle;

determine a relative deviation angle of the yaw angle according to the deviation angle of the yaw angle; and

determine the angular velocity compensation quantity of the yaw angle according to the relative deviation angle of the yaw angle.

In this embodiment of the disclosure, the yaw angle deviation determination and processing module is configured to:

determine the deviation angle of the yaw angle according to the magnetometer yaw angle and a fused yaw angle at a previous moment.

Specifically, the yaw angle deviation determination and processing module 23 is configured to:

acquire an above ground altitude of the aircraft and a flight altitude of the aircraft; and

determine the relative deviation angle of the yaw angle according to the deviation angle of the yaw angle, the above ground altitude of the aircraft and the flight altitude of the aircraft.

Specifically, referring to FIG. 13, FIG. 13 is a schematic structural diagram of the yaw angle deviation determination and processing module in FIG. 12.

As shown in FIG. 13, the yaw angle deviation determination and processing module 23 includes a logical OR operation module 231 and a logical AND operation module 232.

Specifically, the logical OR operation module 231 is configured to:

determine the deviation angle of the yaw angle as the relative offset by which the yaw angle deviates when any of the following conditions is satisfied:

the above ground altitude of the aircraft satisfies a first preset condition;

the flight altitude of the aircraft satisfies a second preset condition; or

a differential of the deviation angle of the yaw angle satisfies a third preset condition.

The first preset condition includes the following: the above ground altitude of the aircraft is greater than 0.4 m for a duration not less than 0.5s.

The second preset condition includes the following: the flight altitude of the aircraft is greater than 0.4 m for a duration not less than 0.5s.

The third preset condition includes the following: an absolute value of the differential of the deviation angle of the yaw angle is less than 0.1 for a duration not less than 0.5s.

Specifically, the logical AND operation module 232 is configured to:

determine a relative error compensation value of the yaw angle as the relative deviation angle of the yaw angle when the following conditions are satisfied:

the above ground altitude of the aircraft satisfies the first preset condition or the flight altitude of the aircraft satisfies the second preset condition;

the differential of the deviation angle of the yaw angle satisfies the third preset condition; and

the relative error compensation value of the yaw angle satisfies a fourth preset condition, where the relative error compensation value of the yaw angle is a difference between the deviation angle of the yaw angle and the relative offset by which the yaw angle deviates.

The fourth preset condition includes the following: an absolute value of the relative error compensation value of the yaw angle is less than 0.1 for a duration not less than 0.5s.

Specifically, the feedback control module 24 is configured to:

calculate the relative deviation angle of the yaw angle by using a feedback control algorithm, to determine the angular velocity compensation quantity of the yaw angle.

In this embodiment of the disclosure, the apparatus for correcting a yaw angle of an aircraft is provided. The apparatus includes: the acquisition module, configured to acquire the IMU data and the magnetometer data, where the IMU data includes the IMU acceleration information and the IMU angular velocity information; the determination module, configured to determine the magnetometer yaw angle according to the magnetometer data; determine the initial value of the yaw angle according to the magnetometer yaw angle; determine the angular velocity compensation quantity of the yaw angle according to the magnetometer data; determine the corrected angular velocity according to the IMU angular velocity information and the angular velocity compensation quantity of the yaw angle; and determine the relative value of the yaw angle according to the corrected angular velocity; and the fused yaw angle generation module, configured to generate the fused yaw angle according to the initial value of the yaw angle and the relative value of the yaw angle. In this way, the disclosure resolves the problem that an indoor aircraft relies on visual information for yaw angle correction and indoor magnetic interference affects the yaw angle correction. Therefore, the stability of the aircraft flying or hovering indoors is enhanced.

Referring to FIG. 14, FIG. 14 is a schematic diagram of a hardware structure of an aircraft according to an embodiment of the disclosure. The aircraft may be a UAV, an unmanned spacecraft, or the like.

As shown in FIG. 14, the aircraft 1400 includes one or more processors 1401, and a memory 1402. In FIG. 14, one processor 1401 is used as an example.

The processor 1401 may be connected to the memory 1402 by a bus or in other manners. In FIG. 14, connection by the bus is used as an example.

The memory 1402 is a non-volatile computer readable storage medium. The memory may be configured to store a non-volatile software program, a non-volatile computer-executable program and a module, for example, units corresponding to the method for correcting a yaw angle of an aircraft in the embodiments of the disclosure (for example, the modules or the units in FIG. 11 to FIG. 13). The processor 1401 executes various functional applications and data processing of the method for correcting a yaw angle of an aircraft by executing the non-volatile software program, the instruction and the module stored in the memory 1402. That is to say, the processor implements the method for correcting a yaw angle of an aircraft in the above method embodiment and the functions of the modules and the units in the foregoing apparatus embodiment.

The memory 1402 may include a high-speed random access memory, and may further include a non-volatile memory, such as at least one magnetic disk memory device, a flash memory device, or other non-volatile solid-state memory devices. In some embodiments, the memory 1402 may optionally include memories remotely disposed relative to the processor 1401. These remote memories may be connected to the processor 1401 by a network. Examples of the above network include, but are not limited to, the Internet, an intranet, a local area network, a mobile communication network, and a combination thereof.

The modules are stored in the memory 1402. When performed by the one or more processors 1401, the modules perform the method for correcting a yaw angle of an aircraft in any of the above method embodiments. For example, the modules perform the above steps shown in FIG. 4 to FIG. 10. The modules may further realize the functions of the modules and the units in FIG. 11 to FIG. 13.

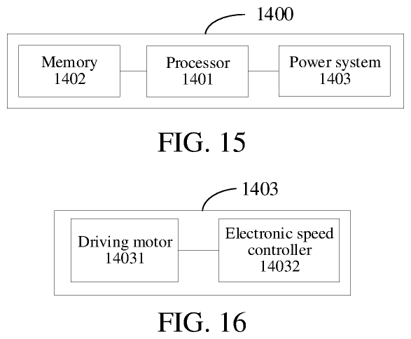

Referring to FIG. 15 and FIG. 16, the aircraft 1400 further include a power system 1403. The power system 1403 is configured to provide flight power for the aircraft. The power system 1403 is connected to the processor 1401. The power system 1403 includes a driving motor 14031 and an ESC 14032. The ESC 14032 is electrically connected to the driving motor 14031, and is configured to control the driving motor 14031. Specifically, the ESC 14032 generates a control instruction based on a fused yaw angle obtained after the processor 1401 performs the above method for correcting a yaw angle of an aircraft, and controls the driving motor 14031 by using the control instruction.

The aircraft 1400 may perform the method for correcting a yaw angle of an aircraft provided in Embodiment I of the disclosure. The aircraft has the corresponding functional modules for performing the method and corresponding beneficial effects. For technical details not described in detail in the embodiment of the aircraft, refer to the method for correcting a yaw angle of an aircraft provided in Embodiment I of the disclosure.

An embodiment of the disclosure provides a computer program product. The computer program product includes a computer program stored in a non-volatile computer readable storage medium. The program instructions, when executed by a computer, cause the computer to perform the above method for correcting a yaw angle of an aircraft. For example, step S10 to step S70 in the above method in FIG. 4 are performed.

An embodiment of the disclosure further provides a non-volatile computer readable storage medium. The computer readable storage medium stores computer-executable instructions. The computer executable-instructions, when executed by one or more processors, for example, the processor 1401 in FIG. 14, cause the one or more processors to perform the method for correcting a yaw angle of an aircraft in any of the above method embodiments. For example, the one or more processors to perform the above steps shown in FIG. 4 to FIG. 10. The one or more processors may further realize the functions of the modules and the units in FIG. 11 to FIG. 13.

The foregoing described apparatus or device embodiments are merely examples. The unit modules described as separate parts may or may not be physically separate, and the parts displayed as unit modules may or may not be physical units, may be located in one position, or may be distributed on a plurality of network module units. Some or all of the modules may be selected according to actual requirements to implement the objectives of the solutions of the embodiments.

Based on the descriptions of the foregoing implementations, a person skilled in the art may clearly understand that the implementations may be implemented by software in addition to a universal hardware platform, or by hardware. Based on such an understanding, the foregoing technical solutions essentially or the part contributing to the related technology may be implemented in a form of a software product. The computer software product may be stored in a computer-readable storage medium, such as a read-only medium (ROM)/a random access memory (RAM), a magnetic disk, or an optical disc, and includes several instructions for instructing a computer device (which may be a personal computer, a server, a network device, or the like) to perform the methods described in the embodiments or some parts of the embodiments.

Finally, it should be noted that the foregoing embodiments are merely used for describing the technical solutions of the disclosure, but are not intended to limit the disclosure. Under the concept of the disclosure, the technical features in the foregoing embodiments or different embodiments may be combined, the steps may be implemented in any sequence, and there may be many other changes in different aspects of the disclosure as described above. For brevity, those are not provided in detail. Although the disclosure is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of the embodiments of the disclosure.

What is claimed is:

1. A method for correcting a yaw angle of an aircraft, applicable to an aircraft, comprising:
acquiring inertial measurement unit (IMU) data and magnetometer data, wherein the IMU data comprises IMU acceleration information and IMU angular velocity information;
determining a magnetometer yaw angle according to the magnetometer data;
determining an initial value of a yaw angle according to the magnetometer yaw angle;
determining an angular velocity compensation quantity of the yaw angle according to the magnetometer data;
determining a corrected angular velocity according to the IMU angular velocity information and the angular velocity compensation quantity of the yaw angle;
determining a relative value of the yaw angle according to the corrected angular velocity; and
generating a fused yaw angle according to the initial value of the yaw angle and the relative value of the yaw angle.

2. The method according to claim 1, wherein the determining a magnetometer yaw angle according to the magnetometer data comprises:
calibrating the magnetometer data, to generate calibrated magnetometer data;
acquiring an attitude angle of the aircraft, and generating a rotation transformation matrix according to the attitude angle of the aircraft;
performing coordinate transformation on the calibrated magnetometer data by using the rotation transformation matrix, to generate the magnetometer data in a ground coordinate system; and
comparing magnetometer data of the aircraft in a standard magnetic field at a current position with the magnetometer data in the ground coordinate system, and calculating the magnetometer yaw angle.

3. The method according to claim 1, wherein the determining an initial value of a yaw angle according to the magnetometer yaw angle comprises:
determining whether the aircraft changes from a stationary state to a moving state at a current moment; and
if so, using the magnetometer yaw angle as the initial value of the yaw angle.

4. The method according to claim 1, wherein the determining an angular velocity compensation quantity of the yaw angle according to the magnetometer data comprises:
determining a deviation angle of the yaw angle according to the magnetometer yaw angle;
determining a relative deviation angle of the yaw angle according to the deviation angle of the yaw angle; and
determining the angular velocity compensation quantity of the yaw angle according to the relative deviation angle of the yaw angle.

5. The method according to claim 4, wherein the determining a deviation angle of the yaw angle according to the magnetometer yaw angle comprises:
determining the deviation angle of the yaw angle according to the magnetometer yaw angle and a fused yaw angle at a previous moment.

6. The method according to claim 4, wherein the determining a relative deviation angle of the yaw angle according to the deviation angle of the yaw angle comprises:
acquiring an above ground altitude of the aircraft and a flight altitude of the aircraft; and
determining the relative deviation angle of the yaw angle according to the deviation angle of the yaw angle, the above ground altitude of the aircraft and the flight altitude of the aircraft.

7. The method according to claim 6, wherein the determining the relative deviation angle of the yaw angle according to the deviation angle of the yaw angle, the above ground altitude of the aircraft and the flight altitude of the aircraft comprises:
determining, according to the above ground altitude of the aircraft and the flight altitude of the aircraft, a relative offset by which the yaw angle deviates; and
determining the relative deviation angle of the yaw angle according to the deviation angle of the yaw angle and the relative offset by which the yaw angle deviates.

8. The method according to claim 7, wherein the determining, according to the above ground altitude of the aircraft and the flight altitude of the aircraft, a relative offset by which the yaw angle deviates comprises:
determining the deviation angle of the yaw angle as the relative offset by which the yaw angle deviates when any of the following conditions is satisfied:
the above ground altitude of the aircraft satisfies a first preset condition;
the flight altitude of the aircraft satisfies a second preset condition; or
a differential of the deviation angle of the yaw angle satisfies a third preset condition.

9. The method according to claim 8, wherein the first preset condition comprises the following:
the above ground altitude of the aircraft is greater than 0.4 m for a duration not less than 0.5s.

10. The method according to claim 8, wherein the second preset condition comprises the following:
the flight altitude of the aircraft is greater than 0.4 m for a duration not less than 0.5s.

11. The method according to claim 8, wherein the third preset condition comprises the following:
an absolute value of the differential of the deviation angle of the yaw angle is less than 0.1 for a duration not less than 0.5s.

12. The method according to claim 8, wherein the determining the relative deviation angle of the yaw angle according to the deviation angle of the yaw angle and the relative offset by which the yaw angle deviates comprises:
determining a relative error compensation value of the yaw angle as the relative deviation angle of the yaw angle when the following conditions are satisfied:
the above ground altitude of the aircraft satisfies the first preset condition or the flight altitude of the aircraft satisfies the second preset condition;
the differential of the deviation angle of the yaw angle satisfies the third preset condition; and
the relative error compensation value of the yaw angle satisfies a fourth preset condition, wherein the relative error compensation value of the yaw angle is a difference between the deviation angle of the yaw angle and the relative offset by which the yaw angle deviates.

13. The method according to claim 12, wherein the fourth preset condition comprises the following:
an absolute value of the relative error compensation value of the yaw angle is less than 0.1 for a duration not less than 0.5s.

14. The method according to claim 4, wherein the determining the angular velocity compensation quantity of the yaw angle according to the relative deviation angle of the yaw angle comprises:
calculating the relative deviation angle of the yaw angle by using a feedback control algorithm, to determine the angular velocity compensation quantity of the yaw angle.

15. An apparatus for correcting a yaw angle of an aircraft, applicable to an aircraft, comprising: at least one processor; and
a memory, communicatively connected to the at least one processor, wherein
the memory stores instructions executable by the at least one processor, the instructions, when executed by the at least one processor, cause the at least one processor to perform the following:
acquiring inertial measurement unit (IMU) data and magnetometer data, wherein the IMU data comprises IMU acceleration information and IMU angular velocity information;
determining a magnetometer yaw angle according to the magnetometer data;
determining an initial value of a yaw angle according to the magnetometer yaw angle;
determining an angular velocity compensation quantity of the yaw angle according to the magnetometer data;
determining a corrected angular velocity according to the IMU angular velocity information and the angular velocity compensation quantity of the yaw angle; and
determining a relative value of the yaw angle according to the corrected angular velocity; and
a fused yaw angle generation module, configured to generate a fused yaw angle according to the initial value of the yaw angle and the relative value of the yaw angle.

16. The apparatus according to claim 15, wherein the processor is configured to:
calibrate the magnetometer data, to generate calibrated magnetometer data;
acquire an attitude angle of the aircraft, and generate a rotation transformation matrix according to the attitude angle of the aircraft;
perform coordinate transformation on the calibrated magnetometer data by using the rotation transformation matrix, to generate the magnetometer data in a ground coordinate system; and
compare magnetometer data of the aircraft in a standard magnetic field at a current position with the magnetometer data in the ground coordinate system, and calculate the magnetometer yaw angle.

17. The apparatus according to claim 15, wherein the processor is configured to:
determine the deviation angle of the yaw angle according to the magnetometer yaw angle and a fused yaw angle at a previous moment;
acquire an above ground altitude of the aircraft and a flight altitude of the aircraft;
determine the relative deviation angle of the yaw angle according to the deviation angle of the yaw angle, the above ground altitude of the aircraft and the flight altitude of the aircraft; and
determine the angular velocity compensation quantity of the yaw angle according to the relative deviation angle of the yaw angle.

18. The apparatus according to claim 17, wherein the processor is configured to:
determine the deviation angle of the yaw angle as the relative offset by which the yaw angle deviates when any of the following conditions is satisfied:
the above ground altitude of the aircraft satisfies a first preset condition;
the flight altitude of the aircraft satisfies a second preset condition; or
a differential of the deviation angle of the yaw angle satisfies a third preset condition.

19. The apparatus according to claim 18, wherein the processor is configured to:
determine a relative error compensation value of the yaw angle as the relative deviation angle of the yaw angle when the following conditions are satisfied:
the above ground altitude of the aircraft satisfies the first preset condition or the flight altitude of the aircraft satisfies the second preset condition;
the differential of the deviation angle of the yaw angle satisfies the third preset condition; and
the relative error compensation value of the yaw angle satisfies a fourth preset condition, wherein the relative error compensation value of the yaw angle is a difference between the deviation angle of the yaw angle and the relative offset by which the yaw angle deviates.

20. An aircraft, comprising:
a fuselage;
an arm, connected to the fuselage;
a power apparatus, disposed on the fuselage and/or the arm and configured to provide flight power for the aircraft; and
a flight controller, disposed on the fuselage and
comprising:
at least one processor, and
a memory, communicatively connected to the at least one processor, wherein
the memory stores instructions executable by the at least one processor, the instructions, when executed by the at least one processor, cause the at least one processor to perform the following:
acquiring inertial measurement unit (IMU) data and magnetometer data, wherein the IMU data comprises IMU acceleration information and IMU angular velocity information;
determining a magnetometer yaw angle according to the magnetometer data;
determining an initial value of a yaw angle according to the magnetometer yaw angle;
determining an angular velocity compensation quantity of the yaw angle according to the magnetometer data;
determining a corrected angular velocity according to the IMU angular velocity information and the angular velocity compensation quantity of the yaw angle;
determining a relative value of the yaw angle according to the corrected angular velocity; and
generating a fused yaw angle according to the initial value of the yaw angle and the relative value of the yaw angle.
